(19) United States
(12) Patent Application Publication
(10) Pub. No.: US 2026/0268454 A1
(43) Pub. Date: Sep. 10, 2026

(54) Medical Image Enhancement and Model Training Method, System, Device and Medium

(71) Applicant: Siemens Healthineers AG, Forchheim (DE)

(72) Inventors: Yun Peng Wang, Shanghai (CN); Jing Lu, Shanghai (CN); Zi Yue Xie, Suzhou (CN)

(73) Assignee: Siemens Healthineers AG, Forchheim (DE)

(21) Appl. No.: 19/560,230

(22) Filed: Mar. 9, 2026

(30) Foreign Application Priority Data
Mar. 10, 2025 (CN) 202510282083.6

(51) Int. Cl. G06T 5/60; G06T 5/50; G06T 5/92; G06T 7/00; G06T 7/174; G06T 7/33; G06T 12/20

(52) U.S. Cl. CPC G06T 5/60; G06T 5/50; G06T 5/92; G06T 7/0012; G06T 7/174; G06T 7/337; G06T 12/20; G06T 2207/20081; G06T 2207/20084; G06T 2207/20132; G06T 2207/20221; G06T 2207/30096; G06T 2210/41

(57) ABSTRACT

The disclosure relates to medical image enhancement and model training. A training method may include: acquiring a non-contrast-agent medical image and a contrast-enhanced image paired therewith; inputting the non-contrast-agent medical image into a single-branch generator, extracting an image feature, and generating an initial virtual enhanced image; inputting the initial virtual enhanced image and contrast-enhanced image into a registration network, aligning the initial virtual enhanced image to a coordinate space, and generating an aligned virtual enhanced image; obtaining a true image discrimination value and a virtual image discrimination value; calculating an adversarial loss of the true image discrimination value and the true label and the virtual image discrimination value and the virtual label, and a correlation loss of the aligned virtual enhanced image and the contrast-enhanced image, and updating the single-branch generator based on the adversarial and correlation losses to obtain a medical image enhancement model.

### CROSS REFERENCE TO RELATED APPLICATIONS

This patent application claims priority to, and the benefit of, Chinese Patent Application No. 202510282083.6, filed Mar. 10, 2025, which is incorporated herein by reference in its entirety.

### BACKGROUND

### Field

The present disclosure relates to the technical field of image recognition, in particular to a medical image enhancement and model training method, a system, a device and a medium.

### Related Art

Conventional medical image enhancement relies on contrast agents to improve image contrast, so as to enhance the visibility of lesions. However, the use of contrast agents is accompanied by a certain safety risk. For example, pregnant women or patients allergic to contrast agents are unable to tolerate contrast agents, so cannot undergo contrast enhanced imaging. In addition, the use of contrast agent scan imaging requires additional scan time and a contrast agent injection procedure, which not only increase the cost of examinations but also prolong the patient waiting time while increasing the operating burden of hospitals. Conventionally, a deep learning model is typically used to generate a virtual enhanced image to replace the contrast agent. However, existing methods of generating virtual enhanced images have problems such as a large amount of computation, misalignment of cross-modal images, and unstable image quality, seriously restricting the clinical application of this technology. Thus, there is a need to provide a medical image enhancement and model training method, a system, a device and a medium.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 is a schematic flow chart of a method for training a medical image enhancement model according to embodiments of the present disclosure.

FIG. 2 is an overall process flow of a method for training a medical image enhancement model according to embodiments of the present disclosure.

FIG. 3 is a schematic flow chart of a method for enhancing a medical image according to embodiments of the present disclosure.

FIG. 4 is an overall process flow of a method for enhancing a medical image according to embodiments of the present disclosure.

FIG. 5 shows a structural block diagram of a system for training a medical image enhancement model according to embodiments of the present disclosure.

FIG. 6 shows a structural block diagram of an electronic device according to embodiments of the present disclosure.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure. The connections shown in the figures between functional units or other elements can also be implemented as indirect connections, wherein a connection can be wireless or wired. Functional units can be implemented as hardware, software or a combination of hardware and software.

In view of the shortcomings of conventional techniques, an object of the present disclosure is to provide a medical image enhancement and model training method, a system, a device, and a computer-readable medium that mitigate the problem of poor imaging precision in virtual enhanced images generated with conventional techniques.

To achieve the above objective and other related objectives, the present disclosure provides a method for training a medical image enhancement model, the training method comprising: acquiring a non-contrast-agent medical image and a contrast-enhanced image paired therewith, wherein the non-contrast-agent medical image may be acquired by a contrast-agent-free medical imaging method, the contrast-enhanced image may be a contrast agent version of a corresponding medical image, and the contrast-enhanced image has a corresponding preset true label; inputting the non-contrast-agent medical image into a single-branch generator, extracting an image feature of the non-contrast-agent medical image, and generating an initial virtual enhanced image, wherein the initial virtual enhanced image has a corresponding preset virtual label; inputting the initial virtual enhanced image and the corresponding contrast-enhanced image into a registration network, aligning the initial virtual enhanced image to a coordinate space in which the corresponding contrast-enhanced image is located, and generating an aligned virtual enhanced image; using a discriminator to respectively obtain a true image discrimination value corresponding to the contrast-enhanced image, and a virtual image discrimination value corresponding to the initial virtual enhanced image; calculating an adversarial loss of the true image discrimination value and the corresponding true label and the virtual image discrimination value and the corresponding virtual label, and calculating a correlation loss of the aligned virtual enhanced image and the contrast-enhanced image, and updating the single-branch generator based on the adversarial loss and the correlation loss to obtain a trained medical image enhancement model, wherein the medical image enhancement model may be the single-branch generator.

In an embodiment of the present disclosure, the non-contrast-agent medical image may comprise images of at least two modalities, and the step of inputting the non-contrast-agent medical image into a single-branch generator, extracting an image feature of the non-contrast-agent medical image, and generating an initial virtual enhanced image, may comprise: stitching the images of the modalities, and inputting a stitched image resulting from stitching into the single-branch generator, extracting an image feature of the stitched image, and generating an initial virtual enhanced image corresponding to the non-contrast-agent medical image.

In an embodiment of the present disclosure, the step of inputting the initial virtual enhanced image and the corresponding contrast-enhanced image into a registration network, aligning the initial virtual enhanced image to a coordinate space in which the corresponding contrast-enhanced image is located, and generating an aligned virtual enhanced image, may comprise: inputting the contrast-enhanced image into a first feature extraction module of the registration network, and extracting a contrast image feature of the contrast-enhanced image; inputting the initial virtual enhanced image into a second feature extraction module of the registration network, and extracting a virtual enhanced image feature of the initial virtual enhanced image; inputting the contrast image feature and the virtual enhanced image feature into a similarity calculating module of the registration network, and calculating a similarity error of the virtual enhanced image feature and the contrast image feature; inputting the similarity error into a deformation field generating module of the registration network, and generating a deformation field based on the similarity error, wherein the deformation field may be used to characterize an amount of deviation of the initial virtual enhanced image relative to the contrast-enhanced image; inputting the deformation field into a resampling module of the registration network, and resampling the initial virtual enhanced image according to the deformation field, to generate an aligned virtual enhanced image.

In an embodiment of the present disclosure, the step of resampling the initial virtual enhanced image according to the deformation field, to generate an aligned virtual enhanced image, may comprise: for each pixel point of the initial virtual enhanced image: extracting a corresponding deviation amount of the pixel point in the deformation field, and judging whether the deviation amount is an integer; if so, correcting a coordinate of the pixel point based on the deviation amount to obtain a corrected pixel point coordinate; otherwise, interpolating the deviation amount based on an interpolation method, and using an interpolated deviation amount to correct a coordinate of the pixel point, to obtain a corrected pixel point coordinate; based on all corrected pixel point coordinates and corresponding pixel values, forming an aligned virtual enhanced image.

In an embodiment of the present disclosure, the discriminator may be a local perception discriminator, and the step of using a discriminator to obtain a true image discrimination value corresponding to the contrast-enhanced image may comprise: inputting the contrast-enhanced image into a cropping module of the local perception discriminator, and cutting the contrast-enhanced image to generate multiple local contrast-enhanced images; inputting the multiple local contrast-enhanced images into a discriminating module of the local perception discriminator, and discriminating the local contrast-enhanced images to generate a true image discrimination value.

In an embodiment of the present disclosure, the discriminator may be a local perception discriminator, and the step of using a discriminator to obtain a virtual image discrimination value corresponding to the initial virtual enhanced image may comprise: inputting the initial virtual enhanced image into a cropping module of the local perception discriminator, and cutting the initial virtual enhanced image to generate multiple local virtual enhanced images; inputting the multiple local virtual enhanced images into a discriminating module of the local perception discriminator, and discriminating the local virtual enhanced images to generate a virtual image discrimination value.

In an embodiment of the present disclosure, the step of calculating an adversarial loss of the true image discrimination value and the corresponding true label and the virtual image discrimination value and the corresponding virtual label, and calculating a correlation loss of the aligned virtual enhanced image and the contrast-enhanced image, and updating the single-branch generator based on the adversarial loss and the correlation loss to obtain a trained medical image enhancement model, may comprise: calculating an adversarial loss of the true image discrimination value and the corresponding true label and the virtual image discrimination value and the corresponding virtual label, and updating the single-branch generator and the discriminator based on the adversarial loss; calculating a correlation loss of the aligned virtual enhanced image and the contrast-enhanced image, and updating the single-branch generator and the registration network based on the correlation loss.

In an embodiment of the present disclosure, a method for enhancing a medical image is further provided, the enhancement method comprising: acquiring a non-contrast-agent medical image; inputting the non-contrast-agent medical image into the medical image enhancement model to generate a virtual enhanced image, wherein the medical image enhancement model is obtained by the method for training a medical image enhancement model as described in any one of the embodiments above, and the medical image enhancement model aligns the non-contrast-agent medical image to a preset coordinate space, and extracts an image feature from the aligned non-contrast-agent medical image, to generate a virtual enhanced image.

In an embodiment of the present disclosure, a system for training a medical image enhancement model is further provided, the system comprising: a data acquisition module, configured to acquire a non-contrast-agent medical image and a contrast-enhanced image paired therewith, wherein the non-contrast-agent medical image may be acquired by a contrast-agent-free medical imaging method, the contrast-enhanced image is a contrast agent version of a corresponding medical image, and the contrast-enhanced image has a corresponding preset true label; a virtual enhanced image generating module, configured to input the non-contrast-agent medical image into a single-branch generator, extract an image feature of the non-contrast-agent medical image, and generate an initial virtual enhanced image, wherein the initial virtual enhanced image has a corresponding preset virtual label; a registration module, configured to input the initial virtual enhanced image and the corresponding contrast-enhanced image into a registration network, align the initial virtual enhanced image to a coordinate space in which the corresponding contrast-enhanced image is located, and generate an aligned virtual enhanced image; a discriminating module, configured to use a discriminator to respectively obtain a true image discrimination value corresponding to the contrast-enhanced image, and a virtual image discrimination value corresponding to the initial virtual enhanced image; a model training module, configured to calculate an adversarial loss of the true image discrimination value and the corresponding true label and the virtual image discrimination value and the corresponding virtual label, and calculate a correlation loss of the aligned virtual enhanced image and the contrast-enhanced image, and update the single-branch generator based on the adversarial loss and the correlation loss to obtain a trained medical image enhancement model, wherein the medical image enhancement model is the single-branch generator.

In an embodiment of the present disclosure, a medical imaging device is further provided, comprising: a capture module, for capturing a non-contrast-agent medical image of an examination subject; and a processing module, configured to input the non-contrast-agent medical image into the medical image enhancement model to generate a virtual enhanced image, wherein the medical image enhancement model aligns the non-contrast-agent medical image to a preset coordinate space, and extracts an image feature from the aligned non-contrast-agent medical image, to generate a virtual enhanced image.

In an embodiment of the present disclosure, an electronic device is further provided, comprising: one or more processor; and a storage means for storing one or more program which, when executed by the one or more processor, causes the electronic device to realize the method for training a medical image enhancement model or the method for enhancing a medical image as described in any one of the embodiments above.

In an embodiment of the present disclosure, a computer-readable storage medium is further provided, having stored thereon a computer program which, when executed by a processor of a computer, causes the computer to perform the method for training a medical image enhancement model or the method for enhancing a medical image as described in any one of the embodiments above.

As described above, the medical image enhancement and model training method, system, device and medium of the present disclosure have the following beneficial effects: compared with a conventional multi-branch generation network, the single-branch generation architecture in this solution significantly reduces computation complexity, improving model training and inference efficiency. Moreover, an initial virtual enhanced image may be aligned with a corresponding true contrast-enhanced image using a registration network to improve the spatial consistency of images, considerably reducing the problem of inter-layer misalignment due to patient movement or scan timing differences, etc. During model training, adversarial losses and correlation losses are combined to optimize the generator, so that the generated virtual enhanced image is closer to the true contrast-enhanced image, while the integrity of the anatomical structure is maintained. The medical image enhancement model obtained by training can generate a high-quality virtual enhanced image without the need for a contrast agent, thus providing a safer and more efficient solution for clinical medical image analysis.

Embodiments of the present disclosure will be explained below by way of specific particular examples, and those skilled in the art will be able to easily understand other advantages and effects of the present disclosure from the content disclosed herein. The present disclosure may also be implemented or applied by way of other particular embodiments, and various modifications or changes may be made to various details herein based on different viewpoints and applications without departing from the spirit of the present disclosure. It must be explained that in the absence of conflict, the embodiments below and features therein can be combined with each other.

It must be explained that the drawings provided in the embodiments below merely illustrate the basic concept of the present disclosure schematically. The drawings only show components relevant to the present disclosure, and are not drawn according to the numbers, shapes and dimensions of components in actual implementation. The forms, numbers and proportions of the various components when actually implemented may be arbitrarily changed, and the layout of the components may be more complicated.

In the description below, many details are discussed to provide more a thorough explanation of embodiments of the present disclosure. However, to those skilled in the art, it is obvious that embodiments of the present disclosure could be implemented without these specific details. In other embodiments, well known structures and devices are shown in the form of block diagrams rather than in the form of details, to avoid making embodiments of the present disclosure difficult to understand.

The inventors have found that conventional medical image enhancement relies on contrast agents to improve image contrast, so as to enhance the visibility of lesions. However, the use of contrast agents not only increases examination costs and scan times, but may also pose a safety risk to certain patient groups. For example, in cardiovascular magnetic resonance (CMR) imaging with late gadolinium enhancement (LGE), gadolinium-based contrast agents (GBCA) must be used during imaging to highlight fibrosis, infarction or other lesion regions. However, there are many drawbacks associated with the use of GBCA in LGE-CMR imaging. Firstly, in patients with severe renal failure or who are allergic to GBCA, GBCA may cause severe adverse reactions, so the use thereof is subject to a warning or is contraindicated; this restricts the suitability of LGE-CMR imaging in these groups. Furthermore, the use of GBCA increases the cost of CMR image examinations, and the scan time is considerably extended due to the need for the patient to carry out related preparation in advance, receive a contrast agent injection, and undergo observation for potential adverse reactions. In addition, the use of GBCA requires injection to be performed by a specialist; in a medical environment with limited resources, this increases the cost of manpower.

Although contrast agent imaging poses many challenges, there are currently very few disclosed documents or patents that attempt to generate virtual native enhancement (VNE) images without the use of GBCA, mainly due to the novelty and complexity of implementation of technology in this field. Existing methods typically use a multi-branch architecture; specifically, they convert multiple different contrast agent-free CMR modalities (e.g. T1-weighted, T2-weighted or Cine MRI sequences) to a target enhancement state. Common architectures generally use multiple independent U-Net branches, extract information from different modalities, and use a converged network to integrate this information at the feature level and the pixel level, so as to synthesize a virtual enhanced image similar in appearance to an LGE image. However, such methods are unable to completely resolve the issue of misalignment in layers. In actual medical applications, displacement due to patient movement will cause misalignment between modalities, thus significantly reducing model performance, and affecting the quality and reliability of the generated virtual enhanced image. In addition, discriminators in existing methods generally only output binary data of a unitary nature (e.g. true/false) to perform judgments; this is too crude for processing quality changes in different regions of the generated image. If a discriminator cannot precisely assess the quality of a local region, the textural fidelity of the generated image will be reduced, and consequently the textural details of the image in certain regions will be poor. Furthermore, a multi-branch architecture has high computation complexity, and this affects the efficiency of generation and significantly increases the cost of computation. Moreover, due to the lack of a module specifically for processing inter-layer misalignment, virtual enhanced images generated by existing methods still have very inadequate stability and reliability, and consequently have poor quality.

To mitigate the abovementioned problems, the present disclosure provides a method for training a medical image enhancement model. Compared with a conventional multi-branch generation network, the single-branch generation architecture in this solution significantly reduces computation complexity, improving model training and inference efficiency. Moreover, an initial virtual enhanced image may be aligned with a corresponding true contrast-enhanced image using a registration network to improve the spatial consistency of images, considerably reducing the problem of inter-layer misalignment due to patient movement or scan timing differences, etc. During model training, adversarial losses and correlation losses are combined to optimize the generator, so that the generated virtual enhanced image is closer to the true contrast-enhanced image, while the integrity of the anatomical structure is maintained. The medical image enhancement model obtained by training can generate a high-quality virtual enhanced image without the need for a contrast agent, thus providing a safer and more efficient solution for clinical medical image analysis.

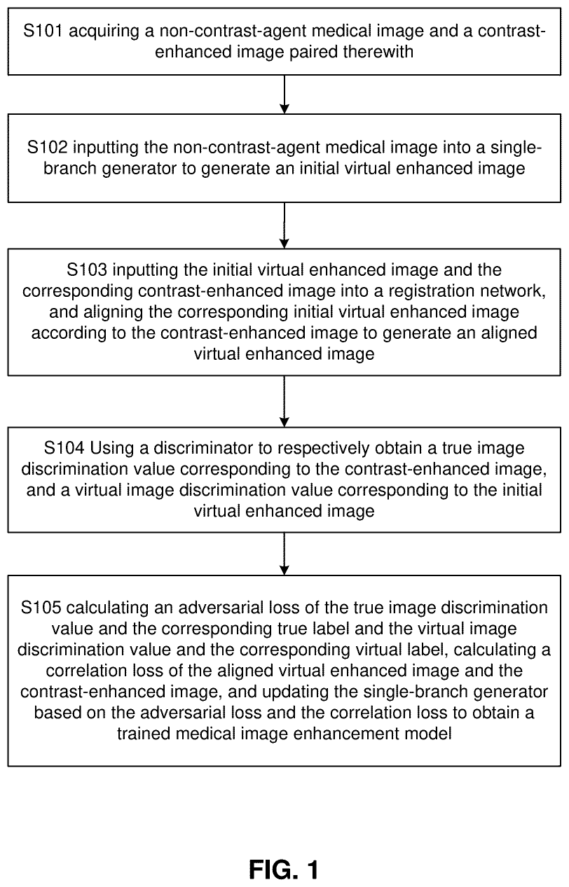

Referring to FIG. 1, a medical image segmentation method may comprise the following steps: S101, S102, S103, S104, and S105.

S101, acquiring a non-contrast-agent medical image and a contrast-enhanced image paired therewith, wherein the non-contrast-agent medical image may be acquired by a contrast-agent-free medical imaging method, the contrast-enhanced image is a contrast agent version of a corresponding medical image, and the contrast-enhanced image has a corresponding preset true label.

The non-contrast-agent medical image may be acquired by conventional non-contrast medical imaging, such as contrast-agent-free MRI (magnetic resonance imaging), CT (computed tomography) or ultrasound, etc. The contrast-enhanced image may be obtained under the same scanning conditions after additional injection of a contrast agent, and can provide clearer contrast between tissue and lesions. Further, the non-contrast-agent medical image and the contrast-enhanced image of the present disclosure refer to image data of a patient acquired by CT, MRI or other medical imaging equipment. After acquiring an original non-contrast-agent medical image or contrast-enhanced image, the original non-contrast-agent medical image or contrast-enhanced image must be subjected to preprocessing in order to adapt to a subsequent model processing procedure, forming a standardized non-contrast-agent medical image and a standardized contrast-enhanced image. The preprocessing includes but is not limited to grayscale normalization, removal of noise from the non-contrast-agent medical image or contrast-enhanced image, and enhancement of contrast, etc. Those skilled in the art can adaptively select a corresponding preprocessing method based on the requirements of the actual application scenario, and no limitations are imposed here.

S102, inputting the non-contrast-agent medical image into a single-branch generator to generate an initial virtual enhanced image, wherein the initial virtual enhanced image has a corresponding preset virtual label.

The non-contrast-agent medical image acquired may be input into the single-branch generator. The single-branch generator automatically extracts and learns spatial and textural information of the image through a series of convolution and feature fusion operations, generating an initial virtual enhanced image corresponding to the non-contrast-agent medical image, wherein the initial virtual enhanced image provides a preliminary visual simulation of a contrast enhancement effect resulting from the use of a contrast agent. The virtual label refers to true/false labeling of the initial virtual enhanced image. For example, the initial virtual enhanced image may be divided into a preset number (e.g. n) of partial virtual enhanced images, each partial virtual enhanced image being correspondingly labeled with a virtual label, which may be set to a first value (e.g. 0), indicating that the image is a generated virtual enhanced image and not a true contrast-enhanced image. Similarly, for each initial virtual enhanced image, the matching contrast-enhanced image is labeled with a true label, which refers to true/false labeling of the contrast-enhanced image. For example, the contrast-enhanced image may be divided into the same number (e.g. n) of partial contrast-enhanced images as the initial virtual enhanced image, each partial contrast image being correspondingly labeled with a true label, which may be set to a second value (e.g. 1), indicating that the image may be a true contrast-enhanced image. These labels are used for subsequent training of the single-branch generator and a discriminator, to optimize the image generating ability of the medical image enhancement model, so as to generate a more accurate virtual enhanced image.

In an embodiment of the present disclosure, the non-contrast-agent medical image may comprise images of at least two modalities, and inputting the non-contrast-agent medical image into a single-branch generator to generate an initial virtual enhanced image may comprise: stitching the images of the modalities, and inputting an image resulting from stitching into the single-branch generator, to generate an initial virtual enhanced image corresponding to the non-contrast-agent medical image. Taking into account the fact that the non-contrast-agent medical images have different modalities, in order to fully utilize the multimodal medical images (for example, simultaneously including T1 map, T2 map, Cine, etc.), these images of different modalities are first stitched on corresponding channels, to generate a multi-channel input image integrating information of each modality. This multi-channel image resulting from stitching may be inputted into the single-branch generator, which automatically learns associations between the modalities through a series of convolution and feature extraction operations, so as to generate an initial virtual enhanced image which is visually similar to a contrast-enhanced image. This novel single-branch generator proposed in the present disclosure replaces an existing multi-branch architecture. This single-branch generator can receive multiple types of contrast-agent-free multimodal images, and efficiently synthesize a virtual enhanced image. By integrating feature extraction and the generating process in a single unified network, the complexity of data processing is greatly reduced, improving processing efficiency, such that the medical image enhancement model obtained by training is more suitable for actual applications in clinical environments. The present disclosure uses a single-branch generator with a lightweight architecture, optimizing the training procedure and significantly reducing the computation overhead. Consequently, the single-branch generator has a faster computing speed and requires fewer computing resources, so is more efficient than a conventional multi-branch method.

S103, inputting the initial virtual enhanced image and the corresponding contrast-enhanced image into a registration network, and aligning the corresponding initial virtual enhanced image according to the contrast-enhanced image to generate an aligned virtual enhanced image.

One of the main challenges faced when generating a virtual enhanced image is the issue of slice misalignment due to patient movement. To mitigate this situation, the present disclosure proposes a registration network, which preprocesses the input initial virtual enhanced image by elastic alignment. Specifically, the initial virtual enhanced image and the corresponding true contrast-enhanced image are separately input into the registration network. By calculating a spatial difference between the virtual enhanced image and the contrast-enhanced image, the registration network generates a deformation field for alignment, used for performing coordinate transformation and resampling of the initial virtual enhanced image, so as to obtain an aligned virtual enhanced image. This alignment process can effectively eliminate the problem of inter-layer misalignment due to patient body movement, breathing or scan timing differences, etc. This method in the present disclosure enhances the alignment and consistency of the generated virtual enhanced image, so that the system is more stable when processing changes in patient anatomical structure and changes in imaging conditions.

In an embodiment of the present disclosure, the step of inputting the initial virtual enhanced image and the corresponding contrast-enhanced image into a registration network, and aligning the corresponding initial virtual enhanced image according to the contrast-enhanced image to generate an aligned virtual enhanced image, may comprise:
inputting the contrast-enhanced image into a first feature extraction module of the registration network, and extracting a contrast image feature of the contrast-enhanced image;
inputting the initial virtual enhanced image into a second feature extraction module of the registration network, and extracting a virtual enhanced image feature of the initial virtual enhanced image;
inputting the contrast image feature and the virtual enhanced image feature into a similarity calculating module of the registration network, and calculating a similarity error of the virtual enhanced image feature and the contrast image feature;
inputting the similarity error into a deformation field generating module of the registration network, and generating a deformation field based on the similarity error, wherein the deformation field may be used to characterize an amount of deviation of the initial virtual enhanced image relative to the contrast-enhanced image; and
inputting the deformation field into a resampling module of the registration network, and resampling the initial virtual enhanced image according to the deformation field, to generate an aligned virtual enhanced image.

The initial virtual enhanced image and the corresponding true contrast-enhanced image are input into the registration network, and the first feature extraction module and the second feature extraction module are used to respectively extract a contrast image feature of the contrast-enhanced image and a virtual enhanced image feature of the initial virtual enhanced image. The parameters of the first feature extraction module and the second feature extraction module may be the same or different, and may be adaptively designed according to the structure of the feature extraction modules. The first feature extraction module/second feature extraction module may be a convolutional neural network, a deep neural network etc., and is not defined here. The similarity calculating module may be used to calculate a similarity error according to the similarity of the two in a feature space, so as to quantify the degree of consistency in spatial structure of the initial virtual enhanced image and the contrast-enhanced image. The similarity calculating module may be a similarity calculating layer or a mean square error calculating layer after a convolution layer, etc., and is not defined here. Using the deformation field generating module, the registration network can learn and generate a deformation field by means of the similarity error, the deformation field being used to indicate the direction in which the initial virtual enhanced image needs to move at each pixel coordinate, relative to the contrast-enhanced image. Thus, the calculated deformation field may be applied to the initial virtual enhanced image, and resampling may be performed to generate an aligned virtual enhanced image. The deformation field generating module may be a U-net structure or a Transformer structure. Specifically, based on the amount of position deviation indicated by the deformation field, the registration network maps corresponding pixel points in the initial virtual enhanced image to new coordinate positions, and uses the resampling module to calculate pixel values at these new coordinates by an interpolation method. Through the process described above, it can be ensured that the virtual enhanced image coincides with the true contrast-enhanced image as much as possible in space, so as to achieve the objective of alignment. It can thus be ensured that the aligned virtual enhanced image is kept consistent with the patient's anatomical structure in space.

In an embodiment of the present disclosure, the step of resampling the initial virtual enhanced image according to the deformation field, to generate an aligned virtual enhanced image, may comprise:
for each pixel point of the initial virtual enhanced image:
   extracting a corresponding deviation amount of the pixel point in the deformation field, and judging whether the deviation amount is an integer;
   if so, correcting a coordinate of the pixel point based on the deviation amount to obtain a corrected pixel point coordinate; and
   otherwise, interpolating the deviation amount based on an interpolation method, and using an interpolated deviation amount to correct a coordinate of the pixel point, to obtain a corrected pixel point coordinate; and
based on all corrected pixel point coordinates and corresponding pixel values, forming an aligned virtual enhanced image.

For each pixel point of the initial virtual enhanced image, the deviation amount corresponding to the pixel point in the deformation field is read. If a level and a perpendicular component of the deviation amount are both integers, the coordinate of the current pixel point is corrected directly according to the integer value, so as to obtain a corrected coordinate position. Conversely, if the deviation amount is a non-integer, the interpolated deviation amount is estimated by an algorithm such as bilinear or bicubic interpolation, and the coordinate is then updated. This allows the positional adjustment of each pixel point to more accurately fit the spatial structure of the true contrast-enhanced image, to avoid the problem of misalignment or information loss caused by simple integer translation. In this way, based on the corrected coordinates of all of the pixel points and their original pixel values, an aligned virtual enhanced image is reconstructed. This is done in order to keep the initial virtual enhanced image consistent with the true contrast-enhanced image as much as possible, while guaranteeing the details of the initial virtual enhanced image.

S104, using a discriminator to respectively obtain a true image discrimination value corresponding to the contrast-enhanced image, and a virtual image discrimination value corresponding to the initial virtual enhanced image.

The true contrast-enhanced image and the initial virtual enhanced image are input into the discriminator; for the input contrast-enhanced image and initial virtual enhanced image, the discriminator learns features such as texture, edges and brightness distribution of the contrast-enhanced image within a local or global range, and outputs a numerical evaluation result for the contrast-enhanced image. Similarly, the discriminator also learns features such as texture, edges and brightness distribution of the initial virtual enhanced image within a local or global range, and outputs a numerical evaluation result for the initial virtual enhanced image. Specifically, the evaluation result of the discriminator for the true contrast-enhanced image is the true image discrimination value. The evaluation result of the discriminator for the initial virtual enhanced image is the virtual image discrimination value. These two values are used to quantitatively compare the true contrast-enhanced image with the initial virtual enhanced image for differences therebetween, and the weighting of the generator may be adjusted on this basis in an adversarial learning phase, so that the generated virtual enhanced image is closer to the true contrast-enhanced image.

In an embodiment of the present disclosure, the discriminator may be a local perception discriminator, and the step of using a discriminator to obtain a true image discrimination value corresponding to the contrast-enhanced image may comprise:
inputting the contrast-enhanced image into a cropping module of the local perception discriminator, and cutting the contrast-enhanced image to generate multiple local contrast-enhanced images; and
inputting the multiple local contrast-enhanced images into a discriminating module of the local perception discriminator, and discriminating the local contrast-enhanced images to generate a true image discrimination value.

The quality of the virtual enhanced image is critical for diagnostic accuracy. To further improve the quality of the virtual enhanced image, the present disclosure proposes a fully convolutional discriminator based on local perception, which performs appraisal in local regions, rather than performing a single judgment for the entire image. Specifically, the cropping module may be used to cut the entire contrast-enhanced image into multiple local contrast-enhanced images according to a given size and step length; for example, a 256×256 image may be segmented into multiple 64×64 or 32×32 feature maps, each feature map being a local contrast-enhanced image. The cropping module may be configured for adaptive region division or fixed-size cropping, etc. The discriminator uses the discriminating module to respectively discriminate each local contrast-enhanced image, using a convolutional neural network therein to analyze details such as local brightness, texture and edges, and outputs a local true image discrimination value for characterizing the trueness of the region in question. The discriminating module may be a convolutional neural network or a Transformer-based local discriminator, a GAN discriminator based on adversarial discrimination, etc., and is not defined herein. After completing discrimination of all local enhanced images, the local true image discrimination values are arranged sequentially in the order of rows and columns according to the spatial position of each local enhanced image in the original contrast-enhanced image, thereby forming a matrix corresponding in size to the original contrast-enhanced image, and this matrix may be taken to be the true image discrimination value. In addition, the generated local true image discrimination values may also be weighted or averaged, etc. to determine the true image discrimination value. In an embodiment, to enable observation of the true contrast-enhanced image at fine granularity, the matrix formed by the local true image discrimination values may be used as the true image discrimination value. This enables finer determination than with single global discrimination, providing a greater amount of local information for subsequent model training and image quality appraisal, increasing the trueness of the synthesized image and reducing the occurrence of artifacts. By using a local perception discriminator, it is ensured that even the smallest details can be accurately captured, increasing the robustness of the entire image generating process.

In an embodiment of the present disclosure, the discriminator may be a local perception discriminator, and the step of using a discriminator to obtain a virtual image discrimination value corresponding to the initial virtual enhanced image may comprise:
inputting the initial virtual enhanced image into a cropping module of the local perception discriminator, and cutting the initial virtual enhanced image to generate multiple local virtual enhanced images; and
inputting the multiple local virtual enhanced images into a discriminating module of the local perception discriminator, and discriminating the local virtual enhanced images to generate a virtual image discrimination value.

The cropping module may be used to cut the entire initial virtual enhanced image into multiple local virtual enhanced images according to a given size and step length; for example, a 256×256 image may be segmented into multiple 64×64 or 32×32 feature maps, each feature map being a local virtual enhanced image. The cropping module may be configured for adaptive region division or fixed-size cropping, etc. The discriminator uses the discriminating module to respectively discriminate each local virtual enhanced image, using an internal convolutional neural network to analyze details such as brightness, texture and edges of the local virtual enhanced image, and outputs a local virtual image discrimination value for characterizing the trueness of the region in question. The discriminating module may be a convolutional neural network or a Transformer-based local discriminator, a GAN discriminator based on adversarial discrimination, etc., and is not defined herein. After completing discrimination of all local virtual enhanced images, the local virtual image discrimination values are arranged sequentially in the order of rows and columns according to the position of each local virtual enhanced image in the initial virtual enhanced image, thereby forming a matrix corresponding in size to the initial virtual enhanced image, and this matrix may be taken to be the virtual image discrimination value. In addition, the generated local virtual image discrimination values may also be weighted or averaged, etc. to determine the virtual image discrimination value. In an embodiment, to enable observation of the virtual enhanced image at fine granularity, the matrix formed by the local virtual image discrimination values may be used as the virtual image discrimination value. This enables finer determination than with single global discrimination, providing a greater amount of local information for subsequent model training and image quality appraisal, increasing the trueness of the synthesized image and reducing the occurrence of artifacts. By using a local perception discriminator, it is ensured that even the smallest details can be accurately captured, increasing the robustness of the entire image generating process.

S105, calculating an adversarial loss of the true image discrimination value and the corresponding true label and the virtual image discrimination value and the corresponding virtual label, and calculating a correlation loss of the aligned virtual enhanced image and the contrast-enhanced image, and updating the single-branch generator based on the adversarial loss and the correlation loss to obtain a trained medical image enhancement model, wherein the medical image enhancement model may be the single-branch generator.

For the true image discrimination value output by the discriminator and the true label corresponding thereto, and the virtual image discrimination value and the virtual label corresponding thereto, the adversarial loss between them is calculated to measure the performance of the model with regard to contrast and textural details. The correlation loss between the aligned virtual enhanced image and the true contrast-enhanced image is calculated to measure the similarity therebetween. The single-branch generator and the discriminator can first be trained iteratively multiple times based on the adversarial loss, then the single-branch generator and the registration network can be trained iteratively multiple times based on the correlation loss; the process described above is repeated, and a trained medical image enhancement model is finally generated by such iterative alternating training.

In an embodiment of the present disclosure, the step of calculating an adversarial loss of the true image discrimination value and the corresponding true label and the virtual image discrimination value and the corresponding virtual label, and calculating a correlation loss of the aligned virtual enhanced image and the contrast-enhanced image, and updating the single-branch generator based on the adversarial loss and the correlation loss to obtain a trained medical image enhancement model, may comprise: calculating an adversarial loss of the true image discrimination value and the corresponding true label and the virtual image discrimination value and the corresponding virtual label, and updating the single-branch generator and the discriminator based on the adversarial loss;
calculating a correlation loss of the aligned virtual enhanced image and the contrast-enhanced image, and updating the single-branch generator and the registration network based on the degree of calculation difference.

The discriminator respectively outputs the true image discrimination value and the virtual image discrimination value; the true label and the virtual label are target signals used to guide the discriminator to learn features of the true contrast-enhanced image and the contrast-free image. By calculating the adversarial loss between them, the model can judge the degree of similarity of the generated virtual enhanced image and the true contrast-enhanced image, and the degree of retention of contrast-free information. Specifically, based on the adversarial loss of the true image discrimination value and the corresponding true label and the virtual image discrimination value and the corresponding virtual label, the adversarial loss can be calculated according to formula (1):

$${min}_{G} {max}_{D} {ℒ}_{Adv} ( D ( G ( x ) ) , D ( \tilde{y} ) ) \qquad ( 1 )$$

where G denotes the single-branch generator, D denotes the discriminator, x denotes the input medical image, \tilde{γ} denotes the contrast-enhanced image, and D(\tilde{γ}) denotes the probability assigned by the discriminator to the true contrast-enhanced image, obtained via the true label. D(G(x)) denotes the probability assigned by the discriminator to the generated virtual enhanced image, obtained via the virtual label.

Based on the correlation loss of the aligned virtual enhanced image and the contrast-enhanced image, the single-branch generator and the registration network can be updated. The correlation loss is as shown in formula (2):

$${min}_{G , R} {ℒ}_{Corr} ( G ( x ) ∘ R ( G ( x ) , \tilde{y} ) , \tilde{y} ) \qquad ( 2 )$$

where G denotes the single-branch generator, x denotes the input medical image, \tilde{γ} denotes the contrast-enhanced image, R denotes the registration network, which outputs the deformation field R(G(x), \tilde{γ}), and ° denotes the resampling process. The generator and the registration network are trained by continuously minimizing the correlation loss. It will be understood that the input medical image may be multimodal images, and may be cropped to adapt to model input requirements; for example, a region to be analyzed, e.g. the heart, may be cropped from the medical image. The cropped medical image may be input into the single-branch generator to undergo analytical processing, wherein the correlation loss includes but is not limited to L1 loss, L2 loss or structural similarity loss.

Further, considering that the cardiovascular structure of each patient is unique, the present disclosure uses a patient-specific image generating mechanism. In the model training and inference phases, slices of different modalities for the same patient are selected, and it is ensured that their inter-layer separation is within a preset threshold, in order to ensure matching of paired data. In this way, the unique anatomical structure of the patient can be better captured and reproduced, to improve the clinical correlation and accuracy of the synthesized virtual enhanced image. It is thus ensured that the generated virtual enhanced image is kept structurally consistent with the actual contrast-enhanced image. Such a method is suitable for various clinical scenarios, especially for patient groups in whom contrast agents cannot be used, thus ensuring the usability of personalized image data for diagnosis and treatment plans.

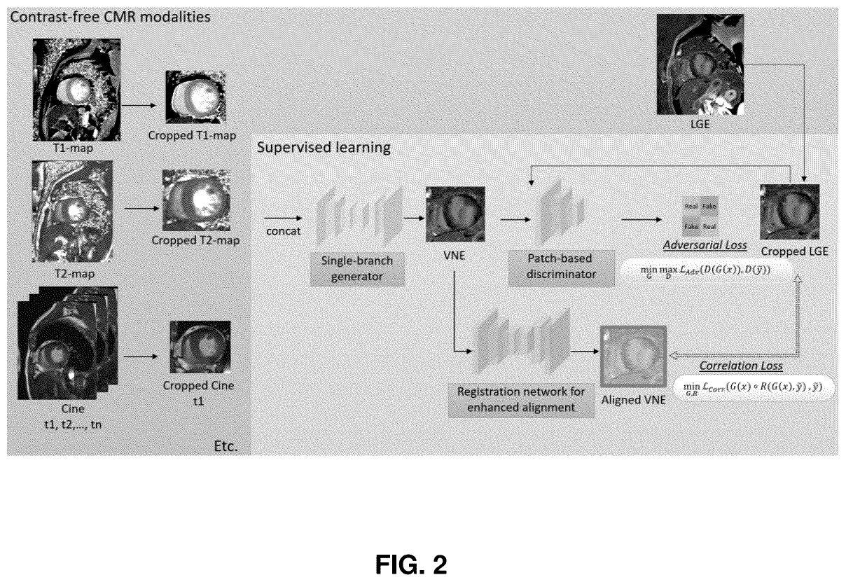

As shown in FIG. 2, taking contrast-agent-free CMR modalities (Contrast-free CMR modalities) as an example, the process of training the medical image enhancement model according to the present disclosure may be as follows: multimodal medical images, for example T1 map, T2 map and dynamic images (Cine), are cropped to obtain corresponding cropped images. For example, after cropping of the multimodal medical images, a T1 map cropped image (Cropped T1-map), a T2 map cropped image (Cropped T2-map) and a dynamic cropped image (Cropped Cine t1) are correspondingly generated. To perform supervised learning, the single-branch generator is trained. The cropped images can be stitched (concat), and input into the single-branch generator to generate an initial virtual enhanced image (e.g. VNE). A contrast-enhanced image (e.g. LGE) may be cropped to obtain a cropped contrast-enhanced image (e.g. Cropped LGE), which may be input into a local perception discriminator (patch-based discriminator) with the initial virtual enhanced image to generate an adversarial loss, and based on this, the generator and the discriminator are trained. In addition, the initial virtual enhanced image may be also input into a registration network (Registration network for enhanced alignment) to generate an aligned virtual enhanced image (e.g. Aligned VNE), and the correlation loss between this and the cropped contrast-enhanced image may be calculated to update the registration network and the generator. In this way, training may be performed in an iterative, alternating manner, to finally obtain a trained medical image enhancement model.

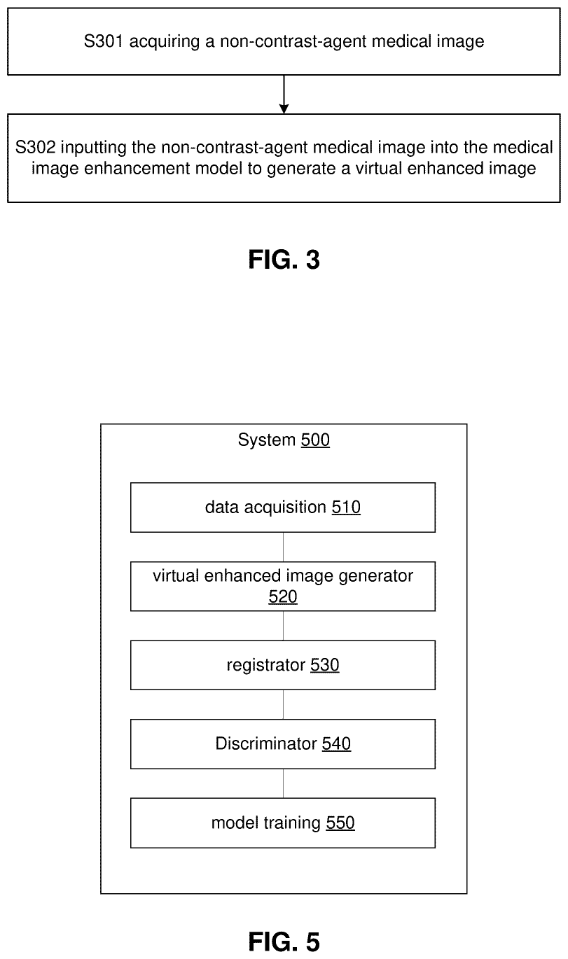

Referring to FIG. 3, the present disclosure also provides a method for enhancing a medical image, the enhancement method comprising:
S301, acquiring a non-contrast-agent medical image;
S302, inputting the non-contrast-agent medical image into the medical image enhancement model to generate a virtual enhanced image, wherein the medical image enhancement model may be obtained by the method for training a medical image enhancement model as described in any one of the embodiments above, and the medical image enhancement model aligns the non-contrast-agent medical image to a preset coordinate space, and extracts image features from the aligned non-contrast-agent medical image, to generate a virtual enhanced image.

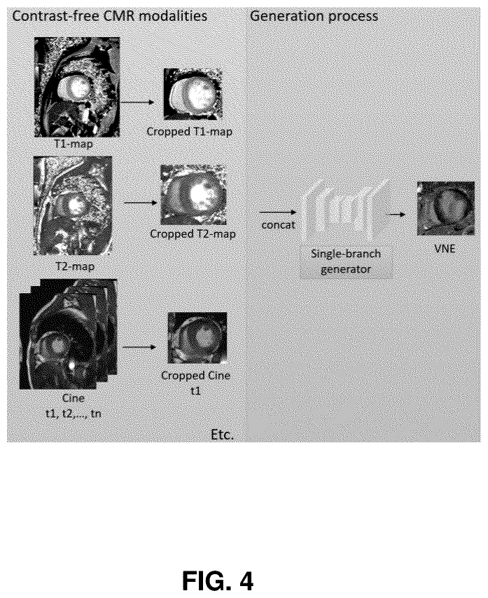

As shown in FIG. 4, taking contrast-agent-free CMR modalities (Contrast-free CMR modalities) as an example, the processing procedure of the inference phase of the present disclosure may be as follows: non-contrast-agent medical images are cropped, for example, T1 map, T2 map and dynamic images (Cine) are cropped, to generate a T1 map cropped image (Cropped T1-map), a T2 map cropped image (Cropped T2-map) and a dynamic cropped image (Cropped Cine t1). In the inference phase (Generation process), the cropped images are stitched (concat) and then input into the trained medical image enhancement model (Single-branch generator) to generate a virtual enhanced image (e.g. VNE). This can be used for subsequent clinical analysis and diagnosis.

The present disclosure further provides a medical imaging device, comprising: a capture module, for capturing a non-contrast-agent medical image of an examination subject; and a processing module, for inputting the non-contrast-agent medical image into the medical image enhancement model to generate a virtual enhanced image, wherein the medical image enhancement model aligns the non-contrast-agent medical image to a preset coordinate space, and extracts image features from the aligned non-contrast-agent medical image, to generate a virtual enhanced image. The capture module may be configured to acquire a non-contrast-agent medical image of a patient, e.g. a contrast-agent-free MRI or CT image; the processing module uses the medical image enhancement model to process the acquired image, to generate a virtual enhanced image. The medical image enhancement model aligns the input non-contrast-agent medical image to a preset coordinate space, to ensure spatial consistency of different images. Aligned image features are extracted, and a virtual enhanced image with an effect similar to contrast enhancement is generated, based on these features. Thus, a high-quality enhanced image can be obtained, without any need for the patient to use a contrast agent. It will be understood that the medical imaging device may be an existing medical image acquisition device, including but not limited to an X-ray machine, a CT machine, an MRI apparatus, an ultrasonic imaging apparatus, etc.; any imaging device suitable for medical image acquisition will suffice, and no restrictions are imposed here. The processing module may be realized on the basis of a computing unit in an existing medical imaging device, or integrated in a device as an independent image processing unit; the specific manner of implementation is not defined. As long as the processing module has the functionality described in the present disclosure, i.e. based on existing image processing functionality, further integrates the medical image enhancement model and is able to subject non-contrast-agent medical images to alignment and feature extraction and perform virtual enhanced image generation, then the medical imaging device having the processing module may be regarded as falling within the scope of protection of the present disclosure.

In summary, the novel algorithm proposed in the present disclosure is more robust than existing methods with regard to virtual enhanced image generation, being able to maintain high-quality image synthesis especially in the case of patient body movement. The quality of the virtual enhanced images generated is superior to that of contrast-enhanced images obtained by accelerated scans or even normal scans. This enhanced robustness ensures that the virtual enhanced images generated can maintain high quality even when the input medical images are of poor quality, thereby increasing the accuracy of clinical assessment, and reducing the requirement for repeated scanning. Time is saved, costs are reduced, and the reliability of image diagnosis is increased. In addition, the single-branch generator used in the present disclosure considerably reduces the computing requirement compared with existing methods, significantly reducing GPU VRAM usage and computing time. Since fast imaging and real-time analysis are vital for medical efficiency, the simplified architecture of the present disclosure accelerates image processing, which is especially advantageous in clinical environments. In addition, the computing requirement reduction will result in lower energy consumption and less cooling, so the entire medical image enhancement model is more sustainable, and the overall operating cost is reduced. In addition, the method has low hardware requirements, so can be widely applied in medical institutions with limited computing resources. The AI algorithm of the present disclosure can cover a wide variety of disease types, so has broad suitability in clinical practice. For example, the method can generate patient-specific virtual enhanced images for a variety of different diseases, such as cardiomyopathy, myocardial infarction, aortic valve disease and myocardial amyloidosis. Thus, the algorithm is of high practical value in many fields of medicine such as pathology and radiology, increasing its application value in patient diagnosis/treatment and disease management.

Referring to FIG. 5, the system 500 for training a medical image enhancement model may comprise: a data acquisition module 510, a virtual enhanced image generating module (generator) 520, a registration module (registrator) 530, a discriminating module (discriminator) 540, and a model training module (trainer) 550. The data acquisition module 510 may be configured to acquire a non-contrast-agent medical image and a contrast-enhanced image paired therewith, wherein the non-contrast-agent medical image may be acquired by a contrast-agent-free medical imaging method, the contrast-enhanced image may be a contrast agent version of a corresponding medical image, and the contrast-enhanced image has a corresponding preset true label. The virtual enhanced image generating module 520 may be configured to input the non-contrast-agent medical image into a single-branch generator, extract an image feature of the non-contrast-agent medical image, and generate an initial virtual enhanced image, wherein the initial virtual enhanced image has a corresponding preset virtual label. The registration module 530 may be configured to input the initial virtual enhanced image and the corresponding contrast-enhanced image into a registration network, align the initial virtual enhanced image to a coordinate space in which the corresponding contrast-enhanced image is located, and generate an aligned virtual enhanced image. The discriminating module 540 may be configured to use a discriminator to respectively obtain a true image discrimination value corresponding to the contrast-enhanced image, and a virtual image discrimination value corresponding to the initial virtual enhanced image. The model training module 550 may be configured to calculate an adversarial loss of the true image discrimination value and the corresponding true label and the virtual image discrimination value and the corresponding virtual label, and calculate a correlation loss of the aligned virtual enhanced image and the contrast-enhanced image, and update the single-branch generator based on the adversarial loss and the correlation loss to obtain a trained medical image enhancement model, wherein the medical image enhancement model may be the single-branch generator.

For the specific definition of the system for training a medical image enhancement model, see the definition of the method for training a medical image enhancement model above, which is not repeated here. Each of the modules in the system for training a medical image enhancement model as described above may be realized wholly or partially by software, hardware and combinations thereof. Each of the modules described above may be in hardware format and embedded in or independent of a processor in a computer device, or may be in software format and stored in a memory in the computer device, to allow the processor to call operations corresponding to each of the modules above. In an exemplary embodiment, the system 500 may include processing circuitry configured to perform one or more functions and/or operations of the system 500. Additionally, or alternatively, one or more components of system 500 (e.g., 510, 520, 530, 540, and/or 550) may include processing circuitry that is configured to perform one or more respective functions of the component(s).

As will be understood, the system may include one or more other modules which have been omitted for brevity and to highlight the innovative parts of the present disclosure.

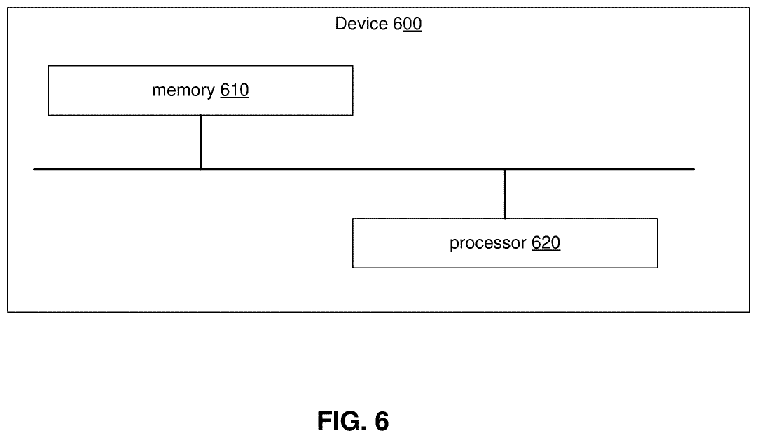

Referring to FIG. 6, the electronic device 600 may comprise a memory 610, a processor 620 and a bus, and may further comprise a computer program stored in the memory 610 and executable on the processor 620, such as a program for medical image enhancement model training or medical image enhancement.

The memory 610 may comprise at least one type of readable storage medium, which includes flash memory, portable hard disk, multimedia card, card memory (e.g. SD or DX memory, etc.), magnetic memory, magnetic disk, optical disk, etc. In some embodiments, the memory 610 may be an internal storage unit of the electronic device 600, e.g. a portable hard disk of the electronic device 600. In other embodiments, the memory 610 may be an external storage device of the electronic device 600, e.g. a plug-in portable hard disk provided on the electronic device 600, a smart media card (SMC), a secure digital (SD) card, a flash card, etc. Further, the memory 610 may also comprise both an internal storage unit of the electronic device 600, and an external storage device. The memory 610 may be used not only to store application software installed on the electronic device 600 and various data, such as code for medical image enhancement model training or medical image enhancement, etc., but also to temporarily store data which has already been output or will be output.

In some embodiments, the processor 620 may include (or be formed by) an integrated circuit, e.g., a single packaged integrated circuit, or may include (or be formed by) multiple packaged integrated circuits with identical or different functions, including one or more central processing units (CPU), microprocessors, digital processing chips, graphics processing units, and combinations of various control chips, etc. The processor 620 may be a control core (controller) of the electronic device 600, using various interfaces and circuits to connect the various components of the entire electronic device 600; it runs or executes programs or modules stored in the memory 610 (e.g. programs for medical image enhancement model training or medical image enhancement, etc.), and calls data stored in the memory 610, in order to execute various functions of the electronic device 600 and process data. The electronic device 600 may include processing circuitry configured to perform one or more functions and/or operations of the electronic device 600. Additionally, or alternatively, one or more components of the electronic device 600 may include processing circuitry that is configured to perform one or more respective functions of the component(s).

The processor 620 may be configured to execute an operating system of the electronic device 600 and various installed application programs. The processor 620 may be configured to execute the application programs to realize steps in the method described above for medical image enhancement model training or medical image enhancement.

For example, the computer program may be segmented into one or more modules; the one or more modules are stored in the memory 610, and executed by the processor 620 to realize the present application. The one or more modules may be a series of computer program instruction segments capable of performing specific functions, the instruction segments being used to describe the process of executing the computer program in the electronic device 600. For example, the computer program may be segmented into the a data acquisition module 510, the virtual enhanced image generating module 520, the registration module 530, the discriminating module 540 and the model training module 550.

The abovementioned integrated units realized in the form of software functional modules may be stored in a computer-readable storage medium, which may be non-volatile or volatile. The abovementioned software functional modules are stored in a storage medium, and include a number of instructions for causing a computer device (which may be a personal computer, a computer device, or a network device, etc.) or a processor to perform some of the functions of the method for medical image enhancement model training or medical image enhancement as described in the embodiments of the present application.

In summary, in the medical image enhancement and model training method and system, device and medium disclosed in the present disclosure, the virtual enhanced image generated by the present disclosure has higher contrast and clarity than a conventional virtual enhanced image, increasing the diagnostic value of images, and helping medical image products to form a competitive advantage in the market. In clinical applications, conventional contrast-enhanced magnetic resonance examination procedures generally require scans of long duration and contrast agent injection, whereas the technology of the present disclosure can completely eliminate the use of a contrast agent, considerably shortening scan times, increasing examination efficiency, and reducing hospital operating costs; moreover, the overall medical service procedure is optimized, reducing the burden on medical staff, and also shortening patient waiting times and improving the experience of going to see a doctor. Further, the present disclosure is especially suitable for patients in whom contrast agents cannot be used, such as patients with renal insufficiency, contrast agent allergy or other contraindications; thus, its suitability in clinical scenarios is expanded, facilitating the promotion and application of image enhancement technology in a larger number of medical institutions. Thus, by optimizing image alignment, improving image quality, reducing computing costs and expanding suitability, the present disclosure surpasses existing methods technically, exhibiting significant advantages in terms of performance, efficiency, cost and suitability. The innovation of this technology not only improves the quality and reliability of image diagnosis, but can also optimize medical work procedures, with far-reaching effects on the promotion and application of medical image enhancement technology. Thus, the present disclosure effectively overcomes various shortcomings in the conventional techniques and has high industrial utilization value.

The above embodiments are merely illustrative of the principles and effects of the present disclosure and are not intended to limit it. Any person familiar with this technology may modify or change the above embodiments without violating the spirit and scope of the present disclosure. Therefore, all equivalent modifications or changes made by those skilled in the art without departing from the spirit and technical ideas disclosed in the present disclosure shall still be covered by the claims of the present disclosure.

To enable those skilled in the art to better understand the solution of the present disclosure, the technical solution in the embodiments of the present disclosure is described clearly and completely below in conjunction with the drawings in the embodiments of the present disclosure. Obviously, the embodiments described are only some, not all, of the embodiments of the present disclosure. All other embodiments obtained by those skilled in the art on the basis of the embodiments in the present disclosure without any creative effort should fall within the scope of protection of the present disclosure.

It should be noted that the terms “first”, “second”, etc. in the description, claims and abovementioned drawings of the present disclosure are used to distinguish between similar objects, but not necessarily used to describe a specific order or sequence. It should be understood that data used in this way can be interchanged as appropriate so that the embodiments of the present disclosure described here can be implemented in an order other than those shown or described here. In addition, the terms “comprise” and “have” and any variants thereof are intended to cover non-exclusive inclusion. For example, a process, method, system, product or equipment comprising a series of steps or modules or units is not necessarily limited to those steps or modules or units which are clearly listed, but may comprise other steps or modules or units which are not clearly listed or are intrinsic to such processes, methods, products or equipment.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general-purpose computer.

The various components described herein may be referred to as “modules,” “units,” or “devices.” Such components may be implemented via any suitable combination of hardware and/or software components as applicable and/or known to achieve their intended respective functionality. This may include mechanical and/or electrical components, processors, processing circuitry, or other suitable hardware components, in addition to or instead of those discussed herein. Such components may be configured to operate independently, or configured to execute instructions or computer programs that are stored on a suitable computer-readable medium. Regardless of the particular implementation, such modules, units, or devices, as applicable and relevant, may alternatively be referred to herein as “circuitry,” “controllers,” “processors,” or “processing circuitry,” or alternatively as noted herein.

For the purposes of this discussion, the term “processing circuitry” shall be understood to be circuit(s) or processor(s), or a combination thereof. A circuit includes an analog circuit, a digital circuit, data processing circuit, other structural electronic hardware, or a combination thereof. A processor includes a microprocessor, a digital signal processor (DSP), central processor (CPU), application-specific instruction set processor (ASIP), graphics and/or image processor, multi-core processor, or other hardware processor. The processor may be “hard-coded” with instructions to perform corresponding function(s) according to aspects described herein. Alternatively, the processor may access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary embodiments described herein, the memory is any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

1. A method for training a medical image enhancement model, comprising:
acquiring a non-contrast-agent medical image and a contrast-enhanced image paired therewith, the non-contrast-agent medical image being acquired by a contrast-agent-free medical imaging method, the contrast-enhanced image being a contrast agent version of a corresponding medical image, and the contrast-enhanced image including a corresponding preset true label;
providing, to a single-branch generator, the non-contrast-agent medical image, extracting an image feature of the non-contrast-agent medical image, and generating an initial virtual enhanced image, wherein the initial virtual enhanced image includes a corresponding preset virtual label;
providing, to a registration network, the initial virtual enhanced image and the corresponding contrast-enhanced image, aligning the initial virtual enhanced image to a coordinate space in which the corresponding contrast-enhanced image is located, and generating an aligned virtual enhanced image;
respectively obtaining, using a discriminator, a true image discrimination value corresponding to the contrast-enhanced image, and a virtual image discrimination value corresponding to the initial virtual enhanced image;
determining an adversarial loss of the true image discrimination value and the corresponding true label, and the virtual image discrimination value and the corresponding virtual label, and determining a correlation loss of the aligned virtual enhanced image and the contrast-enhanced image; and
updating the single-branch generator, based on the adversarial loss and the correlation loss, to obtain a trained medical image enhancement model, wherein the medical image enhancement model is the single-branch generator.

2. The method for training a medical image enhancement model as claimed in claim 1, wherein the non-contrast-agent medical image comprises images of at least two modalities, and wherein the step of providing the non-contrast-agent medical image to the single-branch generator, extracting the image feature of the non-contrast-agent medical image, and generating the initial virtual enhanced image, comprises:
stitching the images of the at least two modalities to generate a stitched image, and providing the stitched image to the single-branch generator, extracting an image feature of the stitched image, and generating an initial virtual enhanced image corresponding to the non-contrast-agent medical image.

3. The method for training a medical image enhancement model as claimed in claim 1, wherein the step of inputting the initial virtual enhanced image and the corresponding contrast-enhanced image into the registration network, aligning the initial virtual enhanced image to the coordinate space in which the corresponding contrast-enhanced image is located, and generating the aligned virtual enhanced image, comprises:
providing the contrast-enhanced image to a first feature extraction module of the registration network, and extracting a contrast image feature of the contrast-enhanced image;
providing the initial virtual enhanced image to a second feature extraction module of the registration network, and extracting a virtual enhanced image feature of the initial virtual enhanced image;
providing the contrast image feature and the virtual enhanced image feature to a similarity calculating module of the registration network, and calculating a similarity error of the contrast image feature and the virtual enhanced image feature;
providing the similarity error to a deformation field generating module of the registration network, and generating a deformation field based on the similarity error, wherein the deformation field is configured to characterize an amount of deviation of the initial virtual enhanced image relative to the contrast-enhanced image; and
providing the deformation field to a resampling module of the registration network, and resampling the initial virtual enhanced image, according to the deformation field, to generate an aligned virtual enhanced image.

4. The method for training a medical image enhancement model as claimed in claim 3, wherein resampling the initial virtual enhanced image, according to the deformation field, to generate the aligned virtual enhanced image, comprises:
for each pixel point of the initial virtual enhanced image:
extracting a corresponding deviation amount of the pixel point in the deformation field, and determining whether the deviation amount is an integer;
based on the deviation amount being an integer, correcting a coordinate of the pixel point based on the deviation amount to obtain a corrected pixel point coordinate; and
based on the deviation amount not being an integer, interpolating the deviation amount based on an interpolation method, and using an interpolated deviation amount to correct a coordinate of the pixel point, to obtain a corrected pixel point coordinate; and
based on all corrected pixel point coordinates and corresponding pixel values, forming an aligned virtual enhanced image.

5. The method for training a medical image enhancement model as claimed in claim 1, wherein the discriminator is a local perception discriminator, and obtaining, using the discriminator, the true image discrimination value corresponding to the contrast-enhanced image comprises:
providing the contrast-enhanced image to a cropping module of the local perception discriminator, and cutting the contrast-enhanced image to generate multiple local contrast-enhanced images; and
providing the multiple local contrast-enhanced images to a discriminating module of the local perception discriminator, and discriminating the local contrast-enhanced images to generate a true image discrimination value.

6. The method for training a medical image enhancement model as claimed in claim 1, wherein the discriminator is a local perception discriminator, and obtaining, using the discriminator, the virtual image discrimination value corresponding to the initial virtual enhanced image comprises:
providing the initial virtual enhanced image into a cropping module of the local perception discriminator, and cutting the initial virtual enhanced image to generate multiple local virtual enhanced images; and
providing the multiple local virtual enhanced images to a discriminating module of the local perception discriminator, and discriminating the local virtual enhanced images to generate a virtual image discrimination value.

7. The method for training a medical image enhancement model as claimed in claim 1, wherein the step of determining the adversarial loss of the true image discrimination value and the corresponding true label, and the virtual image discrimination value and the corresponding virtual label, and determining a correlation loss of the aligned virtual enhanced image and the contrast-enhanced image, and updating the single-branch generator based on the adversarial loss and the correlation loss, comprises:
determining an adversarial loss of the true image discrimination value and the corresponding true label and the virtual image discrimination value and the corresponding virtual label, and updating the single-branch generator and the discriminator based on the adversarial loss; and
determining a correlation loss of the aligned virtual enhanced image and the contrast-enhanced image, and updating the single-branch generator and the registration network based on the correlation loss.

8. An electronic device, comprising:
one or more processors; and
memory storing instructions that, when executed by the one or more processors, cause the electronic device to perform the method of claim 1.

9. One or more non-transitory media storing instructions that, when executed by one or more processors, cause the one or more processors to perform the method of claim 1.

10. A method for enhancing a medical image, comprising:
acquiring a non-contrast-agent medical image; and
providing the non-contrast-agent medical image into a medical image enhancement model to generate a virtual enhanced image, the medical image enhancement model aligning the non-contrast-agent medical image to a preset coordinate space, and extracting an image feature from the aligned non-contrast-agent medical image, to generate the virtual enhanced image.

11. An electronic device, comprising:
one or more processors; and
memory storing instructions that, when executed by the one or more processors, cause the electronic device to perform the method of claim 10.

12. One or more non-transitory media storing instructions that, when executed by one or more processors, cause the one or more processors to perform the method of claim 10.

13. A system for training a medical image enhancement model, comprising:
a data acquisition module configured to acquire a non-contrast-agent medical image and a contrast-enhanced image paired therewith, the non-contrast-agent medical image being acquired by a contrast-agent-free medical imaging method, the contrast-enhanced image being a contrast agent version of a corresponding medical image, and the contrast-enhanced image having a corresponding preset true label;
a virtual enhanced image generator configured to provide the non-contrast-agent medical image to a single-branch generator, extract an image feature of the non-contrast-agent medical image, and generate an initial virtual enhanced image, wherein the initial virtual enhanced image has a corresponding preset virtual label;
a registrator configured to provide the initial virtual enhanced image and the corresponding contrast-enhanced image into a registration network, align the initial virtual enhanced image to a coordinate space in which the corresponding contrast-enhanced image is located, and generate an aligned virtual enhanced image;
a discriminating module, configured to respectively obtain, using a discriminator, a true image discrimination value corresponding to the contrast-enhanced image, and a virtual image discrimination value corresponding to the initial virtual enhanced image; and
a model trainer configured to:
determine an adversarial loss of the true image discrimination value and the corresponding true label, the virtual image discrimination value and the corresponding virtual label, and determine a correlation loss of the aligned virtual enhanced image and the contrast-enhanced image, and
update the single-branch generator, based on the adversarial loss and the correlation loss, to obtain a trained medical image enhancement model, wherein the medical image enhancement model is the single-branch generator.

14. A medical imaging device, comprising:
a medical imaging device configured to capture a non-contrast-agent medical image of an examination subject; and
a processor configured to generate, based on the non-contrast-agent medical image and using a medical image enhancement model, a virtual enhanced image, wherein the medical image enhancement model is configured to align the non-contrast-agent medical image to a preset coordinate space, and extract an image feature from the aligned non-contrast-agent medical image, to generate the virtual enhanced image.
